(19) United States
(12) Patent Application Publication
(10) Pub. No.: US 2015/0149173 A1
(43) Pub. Date: May 28, 2015

(54) Controlling Voice Composition in a Conference

(71) Applicant: Microsoft Corporation, Redmond, WA (US)

(72) Inventor: Jacek A. Korycki, San Jose, CA (US)

(73) Assignee: Microsoft Corporation, Redmond, WA (US)

(21) Appl. No.: 14/091,142

(22) Filed: Nov. 26, 2013

(51) Int. Cl. G10L 17/00

(52) U.S. Cl. CPC G10L 17/00
USPC 704/246

(57) ABSTRACT

Various embodiments enable a system, such as an audio conferencing system, to remove voices from an audio conference in which the removed voices are not desired. In at least some embodiments, an audio signal associated with the audio conference is analyzed and components which represent the individual voices within the audio conference are identified. Once the audio signal is processed in this manner to identify the individual voice components, a control element can be applied to filter out one or more of the individual components that correspond to undesired voices.

### BACKGROUND

Typically today, audio conferencing has become a popular way to exchange information from both a personal and a business standpoint. Yet, in many instances, unintended audio content can make its way into an audio conference. For example, consider a situation in which an audio conference is held between three participants in a first location and a fourth participant in a second location. Assume that the first location is an office environment with a large number of people, and that the three participants use a common computing device to participate in the audio conference. If the office environment is noisy such as, for example, by having other non-participating individuals speaking in a manner which is detected by the audio conferencing system, their voices and conversation can inadvertently make it into the audio conference.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments enable a system, such as an audio conferencing system, to remove voices from an audio conference in which the removed voices are not desired. In at least some embodiments, an audio signal associated with the audio conference is analyzed and components which represent the individual voices within the audio conference are identified. Once the audio signal is processed in this manner to identify the individual voice components, a control element can be applied to filter out one or more of the individual components that correspond to undesired voices.

In various embodiments, the control element can include incorporation of direct user controllability as by, for example, a suitably-configured user interface which enables a user to select one or more individual components for either exclusion or inclusion in the audio conference. Alternately or additionally, the control element can be automatically applied by the audio conferencing system. This can include application of policies, set in advance by way of a group access management system, to govern who can participate in a particular conference.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 illustrates an example environment in accordance with one or more embodiments.

FIG. 4 illustrates an example environment in accordance with one or more embodiments.

FIG. 5 illustrates an example audio conferencing module in accordance with one or more embodiments.

FIG. 6 illustrates various use scenarios in accordance with one or more embodiments.

FIG. 7 is a flow diagram that describes steps in a method in accordance with one or more embodiments.

FIG. 8 is a flow diagram that describes steps in a method in accordance with one or more embodiments.

FIG. 9 is a flow diagram that describes steps in a method in accordance with one or more embodiments.

FIG. 10 illustrates an example environment in accordance with one or more embodiments.

FIG. 11 illustrates various use scenarios in accordance with one or more embodiments.

FIG. 12 is a flow diagram that describes steps in a method in accordance with one or more embodiments.

FIG. 13 is a flow diagram that describes steps in a method in accordance with one or more embodiments.

FIG. 14 is a flow diagram that describes steps in a method in accordance with one or more embodiments.

FIG. 15 illustrates an example computing device that can be utilized to implement various embodiments described herein.

### DETAILED DESCRIPTION

### Overview

Various embodiments enable a system, such as an audio conferencing system, to remove voices from an audio conference in which the removed voices are not desired. In at least some embodiments, an audio signal associated with the audio conference is analyzed and components which represent the individual voices within the audio conference are identified. Once the audio signal is processed in this manner to identify the individual voice components, a control element can be applied to filter out, through a filtering operation, one or more of the individual components that correspond to undesired voices.

In various embodiments, the control element can include incorporation of direct user controllability as by, for example, a suitably-configured user interface which enables a user to select one or more individual components for either exclusion or inclusion in the audio conference. Alternately or additionally, the control element can be automatically applied by the audio conferencing system. This can include application of policies, set in advance by way of a group access management system, to govern who can participate in a particular conference.

In yet other embodiments, a communication event is processed. The communication event comprises a signaling layer containing signal control information for managing the communication event. The signal control information includes identifiers of participants in the communication event. The communication event also includes a media layer containing at least an audio stream comprising voice signals of participants in the communication event. In operation, in at least some embodiments, the audio stream is received and processed to identify individual voices of the participants using at least one characteristic of each voice signal in the media layer. Control data is generated for controlling access of participants to the communication event based on the identified voices.

By processing audio signals and enabling selection and removal of undesired voices as described in this document, a resultant audio signal is provided that more accurately reflects the intended content of an audio conference. This, in turn, enables accurate and efficient dissemination of information amongst audio conference participants in a manner that greatly enhances and improves usability and reliability. Usability is enhanced for reasons that include, by way of example and not limitation, removal of possible ambiguities or noise stemming from the presence of unintended and undesired voices in the audio conference. This, in turn, enhances the reliability of the disseminated information. Thus, at least some of the various approaches allow for access control to a particular audio conference based on including information obtained from a media layer in the signaling layer that is transmitted to and amongst participants.

In the following discussion, an example environment is first described that is operable to employ the techniques described herein. The techniques may be employed in the example environment, as well as in other environments.

Example Environment

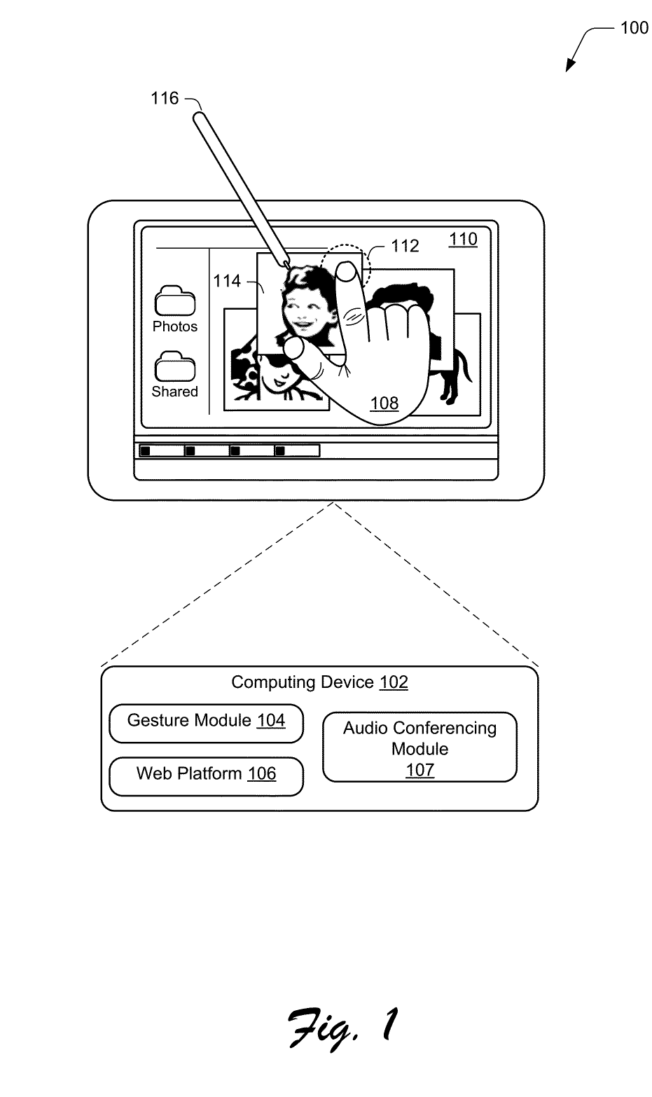

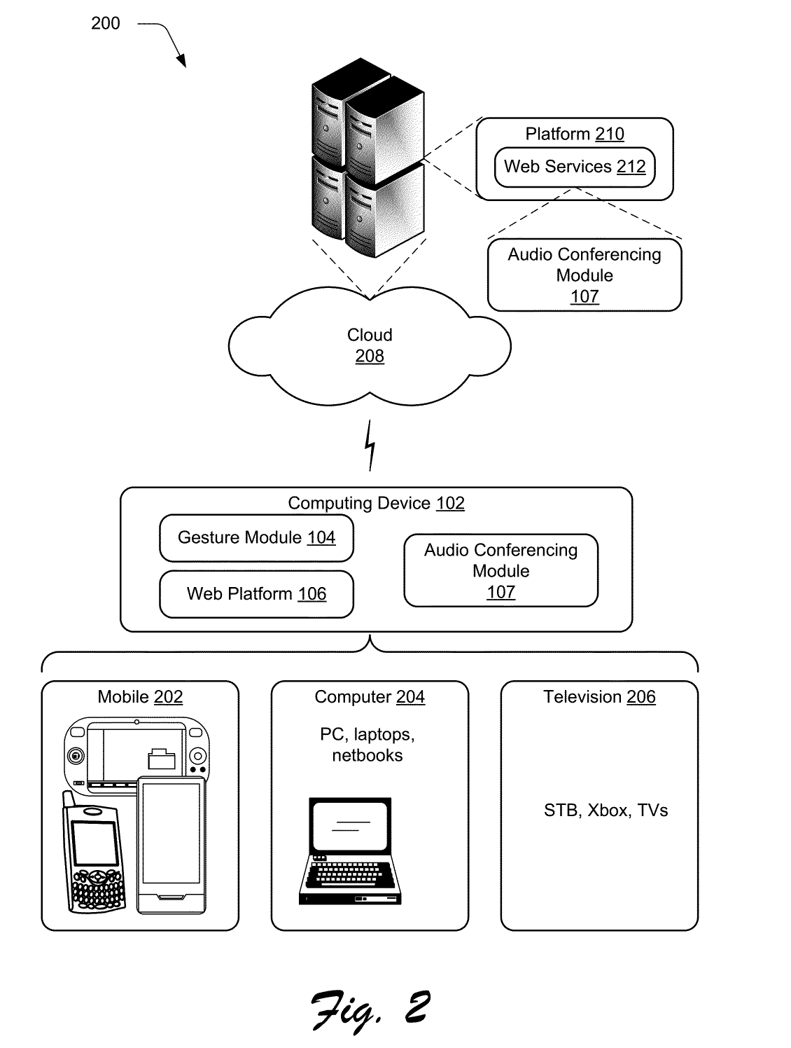

FIG. 1 is an illustration of an environment 100 in an example implementation that is operable to employ the techniques as described herein. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

Computing device 102 includes a number of modules including, by way of example and not limitation, a gesture module 104, a web platform 106, and an audio conferencing module 107.

The gesture module 104 is operational to provide gesture functionality as described in this document. The gesture module 104 can be implemented in connection with any suitable type of hardware, software, firmware or combination thereof. In at least some embodiments, the gesture module 104 is implemented in software that resides on some type of computer-readable storage medium, examples of which are provided below.

Gesture module 104 is representative of functionality that recognizes gestures that can be performed by one or more fingers, and causes operations to be performed that correspond to the gestures. The gestures may be recognized by module 104 in a variety of different ways. For example, the gesture module 104 may be configured to recognize a touch input, such as a finger of a user's hand 108 as proximal to display device 110 of the computing device 102 using touchscreen functionality. For example, a finger of the user's hand 108 is illustrated as selecting 112 an image 114 displayed by the display device 110.

It is to be appreciated and understood that a variety of different types of gestures may be recognized by the gesture module 104 including, by way of example and not limitation, gestures that are recognized from a single type of input (e.g., touch gestures such as the previously described drag-and-drop gesture) as well as gestures involving multiple types of inputs. For example, module 104 can be utilized to recognize single-finger gestures and bezel gestures, multiple-finger/same-hand gestures and bezel gestures, and/or multiple-finger/different-hand gestures and bezel gestures.

For example, the computing device 102 may be configured to detect and differentiate between a touch input (e.g., provided by one or more fingers of the user's hand 108) and a stylus input (e.g., provided by a stylus 116). The differentiation may be performed in a variety of ways, such as by detecting an amount of the display device 110 that is contacted by the finger of the user's hand 108 versus an amount of the display device 110 that is contacted by the stylus 116.

Thus, the gesture module 104 may support a variety of different gesture techniques through recognition and leverage of a division between stylus and touch inputs, as well as different types of touch inputs.

The web platform 106 is a platform that works in connection with content of the web, e.g. public content. A web platform 106 can include and make use of many different types of technologies such as, by way of example and not limitation, URLs, HTTP, REST, HTML, CSS, JavaScript, DOM, and the like. The web platform 106 can also work with a variety of data formats such as XML, JSON, and the like. Web platform 106 can include various web browsers, web applications (i.e. “web apps”), and the like. When executed, the web platform 106 allows the computing device to retrieve web content such as electronic documents in the form of webpages (or other forms of electronic documents, such as a document file, XML file, PDF file, XLS file, etc.) from a Web server and display them on the display device 110. It should be noted that computing device 102 could be any computing device that is capable of displaying Web pages/documents and connect to the Internet.

Audio conferencing module 107 is representative of functionality that enables multiple participants to participate in an audio conference. Typically, an audio conference allows multiple parties to connect to one another using devices such as phones or computers. There are numerous methods and technologies that can be utilized to support audio conferencing. As such, the embodiments described in here can be employed across a wide variety of these methods and technologies. Generally, in an audio conference, voices are digitized into an audio stream and transmitted to a recipient at the other end of the audio conference. There, the audio stream is processed to provide an audible signal that can be played over a speaker or headphones. The techniques described herein can be employed in the context of telephone audio conferencing (e.g., circuit-switched telecommunication systems such as in an audio bridge that forms part of a PSTN system), as well as audio conferencing that takes place by way of a computer over a suitably-configured network such as the Internet. Thus, the techniques can be employed in scenarios such as point-to-point calls as well as a wide variety of other scenarios such as, by way of example and not limitation, Internet-based audio conferences using any suitable type of technology. The audio conferencing module 107 is described in greater detail below.

FIG. 2 illustrates an example system showing the components of FIG. 1, e.g., audio conferencing module 107, as being implemented in an environment where multiple devices can be interconnected through a central computing device. The audio conferencing module 107 can enable audio conferences to be established with one or more other devices as described below.

The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described, the computing device 102 may be configured in a variety of different ways, such as for mobile 202, computer 204, and television 206 uses. Each of these configurations has a generally corresponding screen size and thus the computing device 102 may be configured as one of these device classes in this example system 200. For instance, the computing device 102 may assume the mobile 202 class of device which includes mobile telephones, music players, game devices, and so on. The computing device 102 may also assume a computer 204 class of device that includes personal computers, laptop computers, netbooks, tablets, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the computing device 102 via the Internet or other networks. For example, the audio conferencing module 107, or various functional aspects thereof, may be implemented in part on the computing device 102, as well as via platform 210 that supports web services 212.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the audio conferencing techniques described below can be platform-independent, meaning that the techniques may be implemented on a variety of commercial computing platforms having a variety of processors.

For example, the computing device may also include an entity (e.g., software) that causes hardware or virtual machines of the computing device to perform operations, e.g., processors, functional blocks, and so on. For example, the computing device may include a computer-readable medium that may be configured to maintain instructions that cause the computing device, and more particularly the operating system and associated hardware of the computing device to perform operations. Thus, the instructions function to configure the operating system and associated hardware to perform the operations and in this way result in transformation of the operating system and associated hardware to perform functions. The instructions may be provided by the computer-readable medium to the computing device through a variety of different configurations.

One such configuration of a computer-readable medium is a signal bearing medium and thus is configured to transmit the instructions (e.g., as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

In the discussion that follows, a section entitled “Example System” describes an example system in accordance with one or more embodiments. Next, a section entitled “Use-based Scenarios” describes example scenarios in which the various embodiments can be employed. Following this, a section entitled “Voice Recognition” describes aspects of voice recognition in accordance with one or more embodiments. Next, a section entitled “User Controllability” describes embodiments that facilitate user controllability for controlling the composition of voices in an audio conference. Following this, a section entitled “Automatic Controllability” describes embodiments that facilitate automatic controllability for controlling the composition of voices in an audio conference. Next, a section entitled “Group Access Management Service” describes various group management embodiments that facilitate control of the composition of voices in an audio conference. Last, a section entitled “Example Device” describes aspects of an example device that can be utilized to implement one or more embodiments.

Consider now a discussion of an example system in accordance with one or more embodiments.

Example System

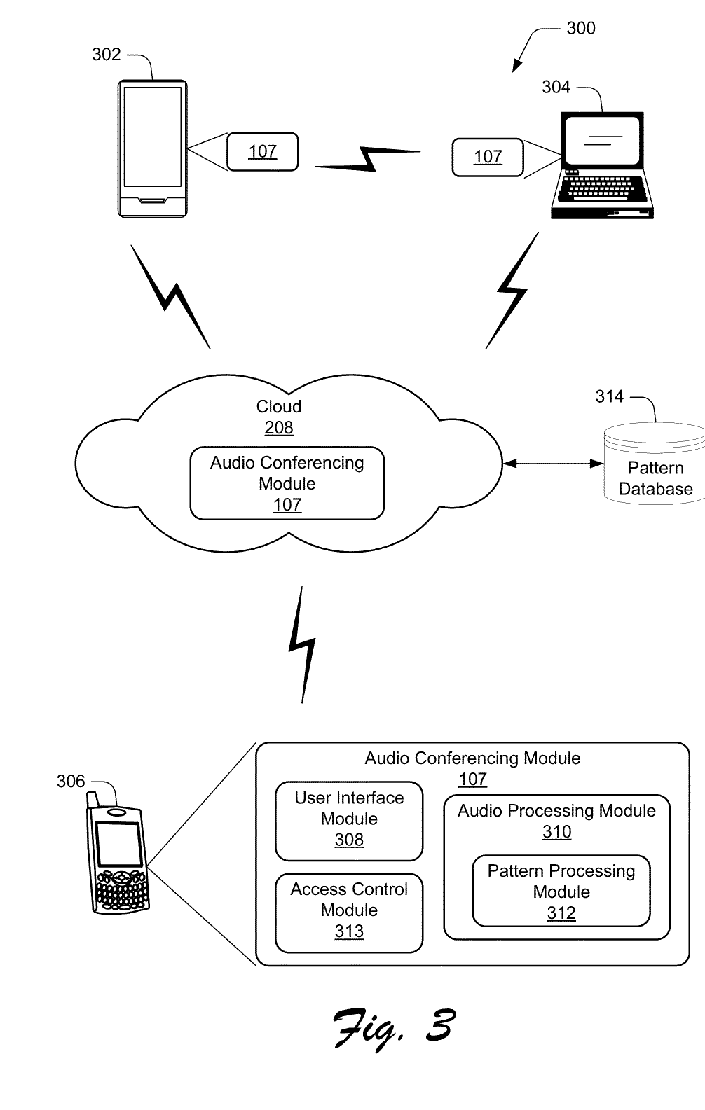

FIG. 3 illustrates an example system in accordance with one or more embodiments generally at 300. In the example about to be described, system 300 enables an audio conference to be established between multiple different users.

In this example, system 300 includes devices 302, 304, and 306. Each of the devices is communicatively coupled with one another by way of a network, here cloud 208, e.g., the Internet. In this particular example, each device includes an audio conferencing module 107 which includes audio conferencing functionality as described above and below. In addition, aspects of the audio conferencing module 107 can be implemented by cloud 208. As such, the functionality provided by the audio conferencing modules can be distributed among the various devices 302, 304, and/or 306. Alternately or additionally, the functionality provided by the audio conferencing modules can be distributed among the various devices and one or more services accessed by way of cloud 208. In at least some embodiments, the audio conferencing module 107 can make use of a suitably-configured database 314 which stores information, such as pattern data that describes voice patterns of individuals who may participate in an audio conference, as will become apparent below. It at least other embodiments, an audio conference can take place through a point-to-point call, as indicated between devise 302, 304.

In this particular example, the audio conferencing modules 107 resident on devices 302, 304, and 306 can include or otherwise make use of a user interface module 308, an audio processing module 310 including a pattern processing module 312, and an access control module 313.

User interface module 308 is representative of functionality that enables the user to interact with the audio conferencing module in order to schedule and participate in audio conferences with other users. Any suitable user interface can be provided by user interface module 308, an example of which is provided below.

Audio processing module 310 is representative of functionality that enables audio to be processed and utilized during the course of an audio conference. The audio processing module 310 can use any suitable approach to processing audio signals that are produced at a site during an audio conference. For example, the audio processing module can include a pattern processing module 312 that can utilize acoustic fingerprinting technology to distinguish multiple independent voices in a particular audio stream in a manner that enables one or more of the independent voices to be filtered or suppressed. Filtering or suppression of voices can take place under the control of a user by way of user interface module 308. Alternately or additionally, filtering or suppression of the voices can take place automatically as described below in more detail. Further, filtering or suppression of one or more voices can take place at an originating device, at one or more of the recipient devices that receive an audio stream, or at a device that is intermediate an originating device and a recipient device (e.g., an audio bridge, a server computer, a web service supported in cloud 208, and the like). Further, processing that is utilized to both identify component voices and filter particular voices can be distributed across multiple devices, such as those just mentioned.

Access control module 313 is representative of functionality that controls access to an audio conference (also referred to as a “communication event”) based on voices identified in an associated audio stream. The access control module may be integrated in any of the other illustrated modules or may constitute a standalone module.

Before describing the various inventive embodiments, consider now a discussion of a few use-based scenarios that provide some context for the various embodiments described below.

Use-based Scenarios

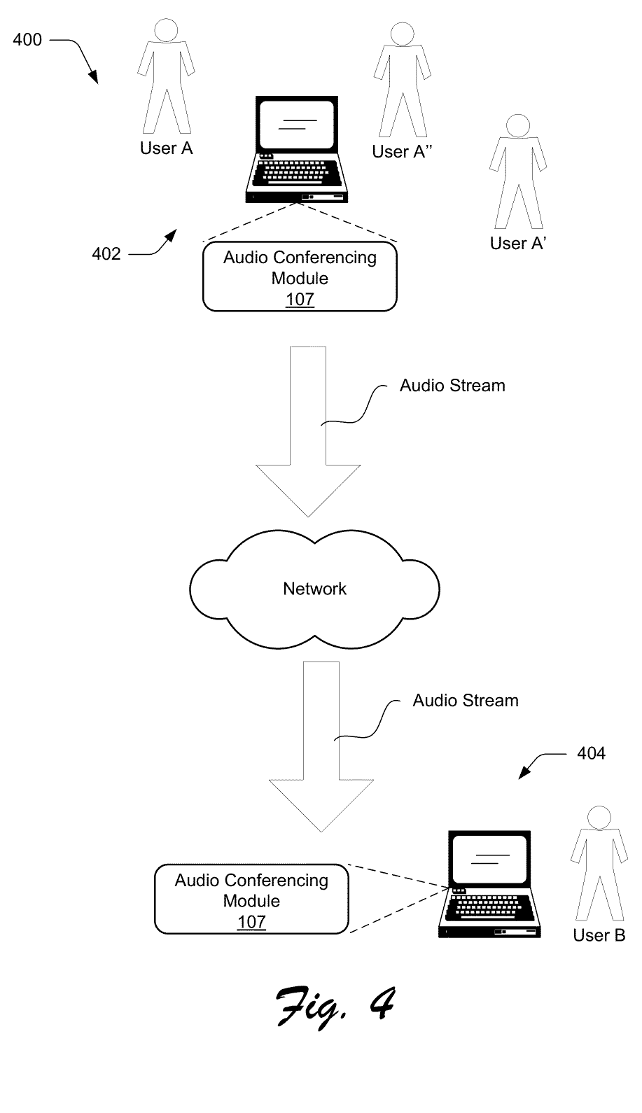

FIG. 4 illustrates an environment, generally at 400, in which a few use-based scenarios will now be described. Environment 400 includes two sites 402, 404. Each site includes a computing device and an audio conferencing module 107 as described above and below. Site 402 includes three users—User A, User A′, and User A″. Site 404 includes a single user—User B.

In the illustrated and described example, an audio conference has been established between sites A and B by way of audio conferencing module 107. In operation, the audio conferencing module 107, e.g. at site A, captures audio from a microphone, digitizes the audio signal, and sends the digitized audio signal over a network in the form of an audio stream as depicted. At site B, the audio conferencing module 107 converts the audio stream into an audible audio signal that is played on a speaker or headphones at the computing device. The audio stream can comprise any suitably-configured audio stream and the techniques described herein can be employed with a wide variety of audio streams. Voice over IP (VoIP) constitutes but one example that utilizes an audio stream implemented using IP packets.

Consider now three different cases or situations that can occur with respect to environment 400.

Case 1

Users A, A′ and A″ are intentionally together, participating in a four-way conference with a remote user B. In this case, it is intended that user B hears users A, A′ and A″. In this case, the audio stream transmitted from site 402 would desirably include the voices of users A, A′ and A″.

Case 2

In this case, the presence of users A′ and A″ is unplanned and undesirable. These users might be engaged in an unrelated conversation with some other people also at site 402, or on the phone. Despite that, the voices of users A′, and A″ are included in the audio stream, and unfortunately are also heard by user B. The voices of users A′, and A″ are not wanted, and create a distraction for user B.

Case 3

The presence of users A and A′ is intentional and they form part of a three-way conference with user B. Presence of user A″ is undesirable and his or her voice creates a distraction for user B.

The embodiments described below provide a solution for each of these cases, as well as other cases, in a manner that provides a crisp, accurate audio stream that enhances audio conferencing sessions. Further, the embodiments described below constitute an advancement over simple application of noise suppression techniques that blindly suppress or filter out all but perhaps the strongest voice or the voice in the foreground. By virtue of the techniques described below, an accurate collection of participants can be defined either manually and/or automatically, thereby ensuring an efficient exchange of information between the participants who are actually supposed to participate in the audio conference. Those who are not supposed to participate in the audio conference can have their voices filtered or otherwise suppressed from the audio stream.

Having considered example cases to which the inventive principles can be applied, consider now some principals associated with voice-recognition.

Voice Recognition

In operation, any suitable voice recognition techniques can be used to process an audio signal and identify multiple different voices. Once identified, individual voices of the multiple different voices can be filtered or suppressed. In the illustrated and described embodiment, a pattern-based approach is utilized to identify and characterize voices that appear in an audio stream. For example, individual voices have patterns that can be recognized and utilized to identify the voices. For example, an individual voice may have a frequency pattern, a temporal pattern, pitch pattern, speech rate, volume pattern or some other pattern that can be utilized, at least in part, to identify and characterize a particular voice. Voices can also be analyzed in terms of various dimensions or vectors to form a fingerprint or pattern of a particular voice. Once a voice's fingerprint is identified, the fingerprint can be used as a basis to filter or suppress the voice from an audio stream, as by using a suitably configured filter or suppression techniques which will be appreciated by the skilled artisan.

But one approach for recognizing the speech of two or more people in a single channel is described in Hershey, 2010, “Super-human multi-talker speech recognition: A graphical modeling approach”, Computer Speech and Language 24 (2010) 45-66. Approaches similar to this one, as well as others can be utilized to identify voice components that comprise part of an audio stream.

Consider now embodiments in which user controllability can be utilized to control the composition of voices in an audio conference.

User Controllability

As noted above, various embodiments enable a system, such as an audio conferencing system, to remove voices from an audio conference in which the removed voices are not desired. In at least some embodiments, and as described in the section just above, an audio signal associated with the audio conference is analyzed and components which represent the individual voices within the audio conference are identified. Once the audio signal is processed in this manner to identify the individual voice components, a control element can be applied to filter out one or more of the individual components that correspond to undesired voices.

In various embodiments, the control element can include incorporation of direct user controllability as by, for example, a suitably-configured user interface which enables a user to select one or more individual components for either exclusion or inclusion in the audio conference.

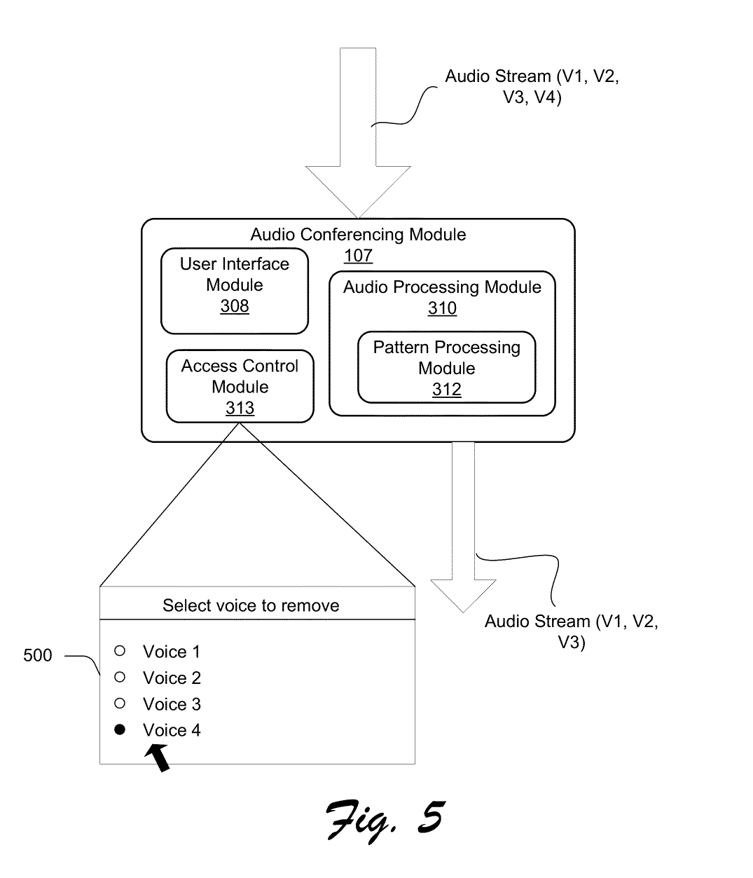

As an example, consider FIG. 5. There, an audio conferencing module 107 is shown receiving an audio stream that includes four voices—V1, V2, V3, and V4. Assume in this example that voice V4 is undesired. That is, voice V4 is provided from a source other than one who is supposed to be participating in an audio conference. The audio conferencing module 107 receives the audio stream and, using the audio processing module 310 and its associated pattern processing module 312, processes the audio stream to identify the four component voices contained within the audio stream—here, voices V1, V2, V3, and V4. Using this information, user interface module 308 can present, through access control functionality here embodied by an access control module 313, a control element in the form of a user interface 500 that provides the user with an opportunity to remove one or more of the voices. In this particular example, the user has clicked on or otherwise selected voice V4 for removal, as indicated by the filled-in circle. As a result, a filter is applied to the audio stream that was received to remove voice V4. The resultant audio stream, as indicated exiting the audio conferencing module 107, includes voices V1, V2, and V3. The access control functionality can also, in other embodiments, be applied automatically based on voices that are identified in an audio stream, as described below in more detail.

In at least some embodiments, pattern processing module 312 is configured to work by identifying the individual component voices without prior knowledge of voices' patterns. Alternately or additionally, the pattern processing module 312 can be configured to work in concert with a pattern database, such as pattern database 314 (FIG. 3), which contains mappings of voice fingerprints to user names. In this manner, one or more of the “Voice N” designators in user interface 500 can be replaced with an actual user name corresponding to the source of the voice. For example, pattern processing module 312 can process the audio stream to identify individual voices within the audio stream. A fingerprint pattern of each of the individual voices can be computed and provided to an entity that has access to pattern database 314. The entity can either be local or remote from the computing device having the pattern processing module 312. The provided patterns can then be used to search the pattern database 314 to identify matches for the patterns. Once identified, the names associated with matching patterns can then be provided for use in user interface 500. This can, in many instances, facilitate the user's selection to suppress one or more of the voices that appear in an audio stream. For example, if the user knows that they are in conference with Fred, Dale, and Alan and these names appear in user interface 500 along with Larry, the user can quickly select to suppress or filter out Larry's voice.

The approach just described can be used to address each of the cases outlined above. In case 1, none of the voices would be selected because all of the voices are intended to be part of the audio conference. In case 2, control can be exercised over the audio stream to suppress or filter all of the voices except one. It is noted, that this may immediately address the problem if the selected voice components indeed belong to those voices that are desired to be removed. If the user selects the wrong voice or voices, they may try again to modify their selections. In case 3, control can be exercised over the audio stream to suppress one voice. The user may retry their efforts in the event the wrong voice is selected. Of course, using a pattern database that enables voices to be mapped to names can mitigate the trial and error nature of filtering or suppressing voices.

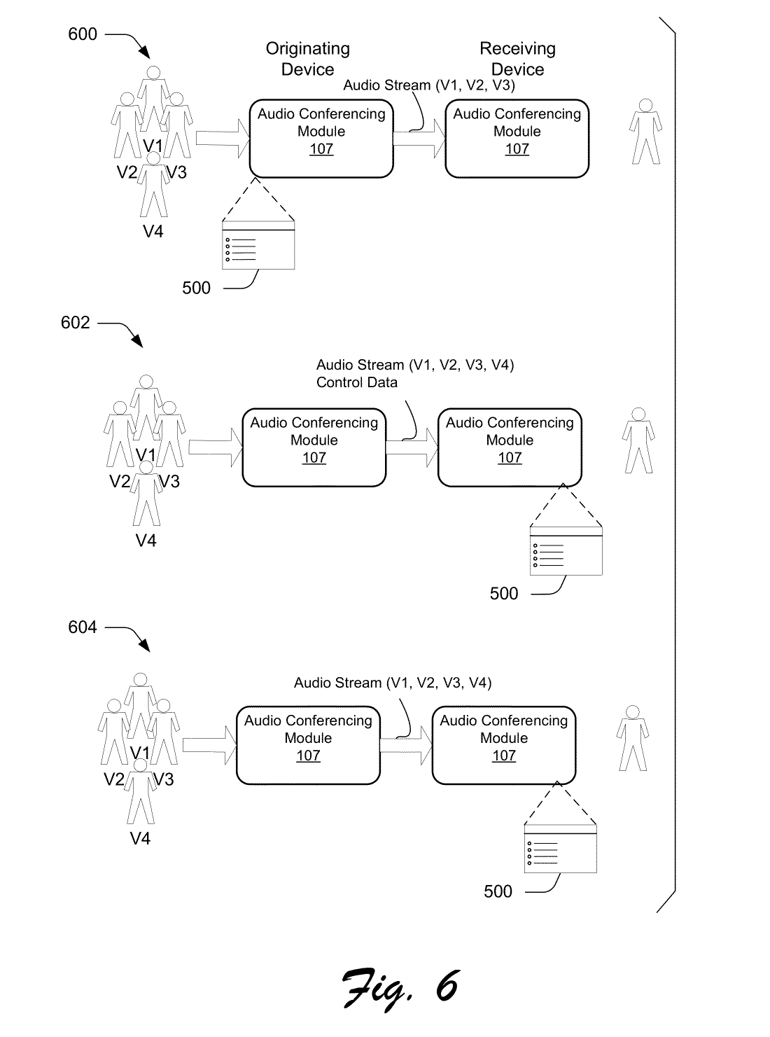

As noted above, the audio conferencing module 107 and its associated functionality can be implemented at each particular device participating in an audio conference. In addition, aspects of this functionality can be distributed across various devices participating in the audio conference. As an example, consider FIG. 6. There, three different scenarios are shown respectively at 600, 602, and 604.

In scenario 600, four participants are shown at an originating device and one participant is shown at a receiving device. In this particular example, assume that voice V4 is an undesired voice, as in the FIG. 5 example. In this particular instance, the audio conferencing module 107 at the originating device analyzes the audio signal having voice components V1, V2, V3, and V4 and identifies the components which represent the individual voices within the audio conference. Once the individual components are identified, a control element in the form of user interface 500 can enable a user at the originating device to filter out one or more of the individual components that correspond to undesired voices. Here, the user has selected to filter out voice V4 and the resultant audio stream contains voices V1, V2, and V3, and not V4.

In scenario 602, the same four participants are shown at the originating device and one participant is shown at the receiving device. In this particular example, assume that voice V4 is an undesired voice, as in the FIG. 5 example. In this particular instance, the audio conferencing module 107 at the originating device analyzes the audio signal having voice components V1, V2, V3, and V4 and identifies the components which represent the individual voices within the audio conference. Once the individual components are identified, the audio conferencing module provides control data identifying each particular voice within the audio stream. The complete audio stream with all four voices and the control data are transmitted to the receiving device. At the receiving device, the control data is used to enable a control element in the form of user interface 500 to enable the user at the receiving device to filter out or effect filtering of one or more of the individual components that correspond to undesired voices. Here, the user at the receiving device has selected to filter out voice V4. The resultant audio stream contains voices V1, V2, and V3, and not V4 and can be played for the user. Alternately or additionally, when the user at the receiving device makes their selection, their choice can be conveyed back to the originating device so that the originating device can affect the filtering. In this manner, the receiving device can remotely cause the originating device to filter undesired voices.

In scenario 604, the same four participants are shown at the originating device and one participant is shown at the receiving device. In this particular example, assume that voice V4 is an undesired voice, as in the FIG. 5 example. In this particular instance, the audio conferencing module 107 at the originating device processes the audio signal having voice components V1, V2, V3, and V4 and transmits the audio stream, complete with the four voices, to the receiving device. At the receiving device, the audio conferencing module 107 processes the audio stream and identifies the components which represent the individual voices within the audio conference. Once the individual components have been identified, a control element in the form of user interface 500 can enable the user at the receiving device to filter out one or more of the individual components that correspond to undesired voices. Here, the user has selected to filter out voice V4 and the resultant audio stream contains voices V1, V2, and V3, and not V4.

Having considered example scenarios in accordance with one or more embodiments, consider now example methods in accordance with one or more embodiments.

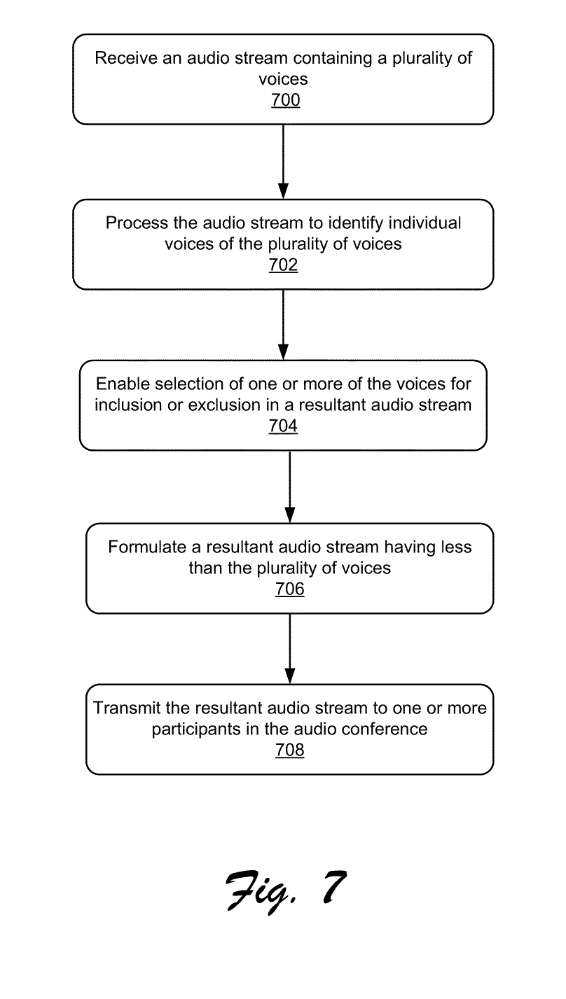

FIG. 7 is a flow diagram that describes steps in a method in accordance with one or more embodiments. The method can be implemented in connection with any suitable hardware, software, firmware, or combination thereof. In one or more embodiments, aspects of the method can be implemented by a suitably-configured audio conferencing module, such as audio conferencing module 107 described above. The audio conferencing module can reside on any of the computing devices described in relation to FIGS. 1-4, as well as others, without departing from the spirit and scope of the claimed subject matter. In addition, the functionality performed by the audio conferencing module can be distributed across multiple computing devices.

Step 700 receives an audio stream containing a plurality of voices. In the illustrated and described embodiments, the voices are part of an audio stream that is generated during an audio conference with one or more remote participants. Step 702 processes the audio stream to identify individual voices of the plurality of voices. This step can be performed in any suitable way, examples of which are provided above, e.g., by using any suitable type of voice recognition technique. Step 704 enables selection of one or more of the voices for inclusion or exclusion in a resultant audio stream. This step can be performed in any suitable way. For example, in at least some embodiments, this step can be performed by providing a control element in the form of a user interface that enables the user to select one or more of the voices for inclusion or exclusion in the resultant audio stream. Responsive to selection of one or more of the voices in step 704, step 706 formulates a resultant audio stream having less than the plurality of voices. The step can be performed in any suitable way. For example, in at least some embodiments, if a user opts to exclude one or more voices, a filter can be applied to the audio stream to formulate the resultant audio stream. Once the resultant audio stream has been formulated, step 708 transmits the resultant audio stream to one or more participants in the audio conference. This method pertains to the processing described in connection with scenario 600 in FIG. 6.

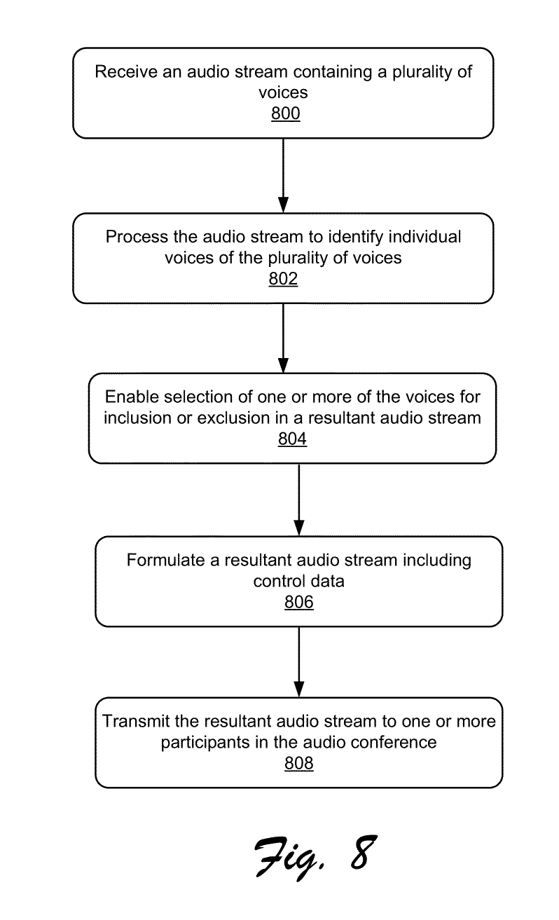

FIG. 8 is a flow diagram that describes steps in a method in accordance with one or more embodiments. The method can be implemented in connection with any suitable hardware, software, firmware, or combination thereof. In one or more embodiments, aspects of the method can be implemented by a suitably-configured audio conferencing module, such as audio conferencing module 107 described above. The audio conferencing module can reside on any of the computing devices described in relation to FIGS. 1-4, as well as others, without departing from the spirit and scope of the claimed subject matter. In addition, the functionality performed by the audio conferencing module can be distributed across multiple computing devices.

Step 800 receives an audio stream containing a plurality of voices. In the illustrated and described embodiments, the voices are part of an audio stream that is generated during an audio conference with one or more remote participants. Step 802 processes the audio stream to identify individual voices of the plurality of voices, e.g., by using any suitable type of voice recognition technique. This step can be performed in any suitable way, examples of which are provided above. Step 804 enables selection of one or more of the voices for inclusion or exclusion in a resultant audio stream. This step can be performed in any suitable way. For example, in at least some embodiments, this step can be performed by generating control data that defines each voice component in the audio stream. Responsive to enabling selection of the voices in step 804, step 806 formulates a resultant audio stream, including the control data. Once the resultant audio stream has been formulated, step 808 transmits the resultant audio stream to one or more participants in the audio conference. Now, using the control data, a user of the receiving device can be presented with a control element in the form of a user interface which can then be used to remove one or more of the voices, as described above. This can be done either at the receiving device or at the originating device. In the latter case, control data can be transmitted back to the originating device to enable the originating device to filter undesired voices. This method pertains to the processing described in connection with scenario 602 in FIG. 6.

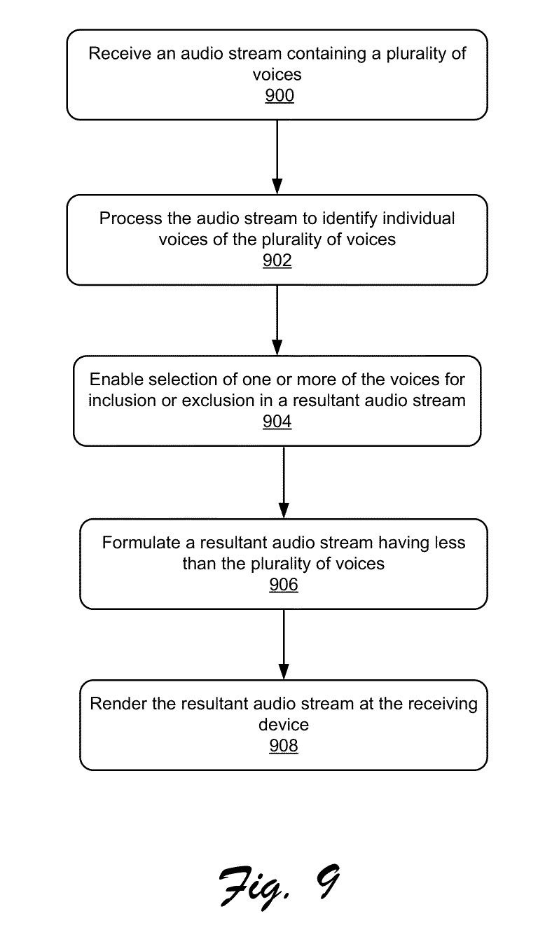

FIG. 9 is a flow diagram that describes steps in a method in accordance with one or more embodiments. The method can be implemented in connection with any suitable hardware, software, firmware, or combination thereof. In one or more embodiments, aspects of the method can be implemented by a suitably-configured audio conferencing module, such as audio conferencing module 107 described above. The audio conferencing module can reside on any of the computing devices described in relation to FIGS. 1-4, as well as others, without departing from the spirit and scope of the claimed subject matter. In addition, the functionality performed by the audio conferencing module can be distributed across multiple computing devices.

Step 900 receives, at a receiving device, an audio stream containing a plurality of voices. In the illustrated and described embodiments, the voices are part of an audio stream that was generated during an audio conference at a remote sending device. Step 902 processes the audio stream to identify individual voices of the plurality of voices, e.g., by using any suitable type of voice recognition technique. This step can be performed in any suitable way, examples of which are provided above. Step 904 enables selection of one or more of the voices for inclusion or exclusion in a resultant audio stream. This step can be performed in any suitable way. For example, in at least some embodiments, this step can be performed by providing a control element in the form of a user interface that enables the user at the receiving device to select one or more of the voices for inclusion or exclusion in the resultant audio stream. Responsive to selection of one or more of the voices in step 904, step 906 formulates a resultant audio stream having less than the plurality of voices. The step can be performed in any suitable way. For example, in at least some embodiments, if a user opts to exclude one or more voices, a filter can be applied to the audio stream to formulate the resultant audio stream. Once the resultant audio stream has been formulated, step 908 renders the resultant audio stream at the receiving device over, for example, one or more speakers or headphones. This method pertains to the processing described in connection with scenario 604 in FIG. 6.

Having considered various methods in accordance with one or more user controllability embodiments, consider now embodiments in which voice composition is controlled automatically.

Automatic Controllability

As noted above, the control element that enables one or more voices to be suppressed can be automatically applied by the audio conferencing system. This can include application of policies, set in advance by way of a group access management system, to govern who can participate in a particular conference.

As noted above, the audio conferencing module can work in connection with a pattern database where voice patterns are made in advance and stored in the database for subsequent use. These stored voice patterns can be used in not only the user-control mode, but the automatic mode as well.

For example, each user may train the audio conferencing module by demonstrating his or her own voice, and then store the acoustic fingerprint of his or her own voice in a suitably configured pattern database. This can be stored locally on a particular device, or stored centrally in a backend database, as part of the user service profile accessible via a network, and then retrieved from the database each time the user logs in. In this manner, the audio conferencing module may, by default, suppress on the ingress side any voice that does not match the acoustic fingerprint of the user or users logged into the audio conferencing module.

Note, that in in some instances in the automatic mode, the user may desire to include other voices in the audio stream. This would be the situation in cases 1 and 3 above. In this case, the audio conferencing module can provide a way to turn off automatic suppression of non-matching voices by, for example, a suitable user interface button. In this manner, the user may then make an ad hoc determination of selected desired/undesired voices, as described above. As such, the methods described above and below can be applied to multiparty audio conferences other than simply point-to-point conferences.

Group Access Management Service

The embodiment about to be described uses group management in the form of a roster to control access to various audio conferences. The embodiments described below automatically apply access control as defined by a group management service.

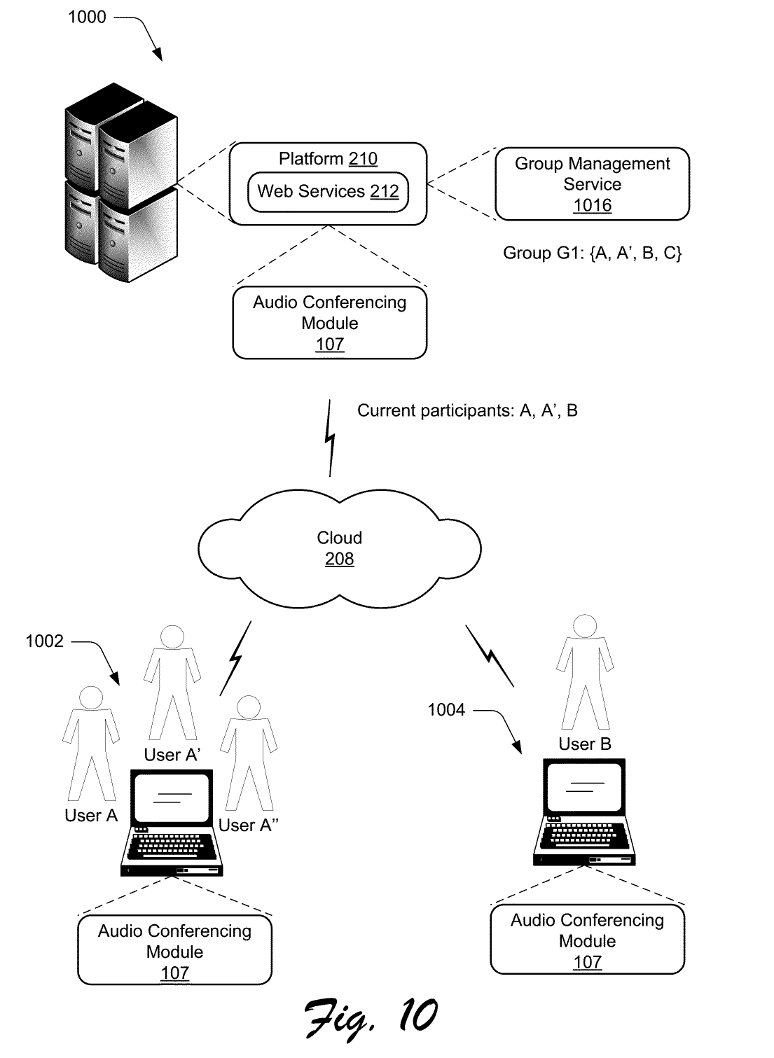

As an example, consider FIG. 10 which illustrates an example system 1000 in accordance with one or more embodiments. In this example, system 1000 includes two devices 1002, 1004 and associated users that are participating in an audio conference. Device 1002 is associated with three different users—user A, user A′, and user A″. Assume that user A″ is an undesired user. Device 1004 is associated with user B. Each of the devices includes an audio conferencing module 107 as described above and below. Devices 1002, 1004, are communicatively connected by way of a network such as cloud 208, described above. A platform 210 includes web services 212 as described above. In this particular example, the platform 210 includes an audio conferencing module 107 and a group management service 1016. In this example, assume also that the group management service 1016 and/or audio conferencing module 107 of platform 210 have access to a pattern database, such as that described above, that includes acoustic patterns of at least some of the voices that are to participate in the audio conference.

Group management service 1016 serves as a policy engine that defines various groups that can participate in audio conferences. These groups can be defined in advance of an audio conference. In operation, the group management service can maintain thousands or even millions of groups. In this particular example one group—G1—is defined to include four users: A, A′, B and C. These are the approved users that are to participate in an audio conference that is administered by the audio conferencing module 107 of platform 210. The group management service, in this example, defines the group that is to participate in the audio conference and the audio conferencing module of platform 210 administers the policy as defined by the group management service. That is, once the group is defined, the audio conferencing module can administer a conference that permits those users who are defined as part of the group to participate in the audio conference and exclude other users who are not defined to be part of the group.

Consider now device 1002 and its associated users. Assume in this example that device 1002 belongs to a user A. When user A joins an audio conference, they are admitted to the audio conference based on signal control information that is transmitted to the platform 210. So, for example, user A may be admitted to the audio conference based on login information that they supply through device 1002. Similarly, user B is admitted to the audio conference based on similar type signal control information. Specifically, when user B logs into the audio conference, their login information along with the policy defined by group management service 1016 enables user B to be admitted to the audio conference. Now consider, with respect to device 1002, users A′ and A″. User A′ is defined to be an authorized participant in the audio conference, as specified by the group management service 1016. Accordingly, user A′ can be admitted to the audio conference based on their voice being recognized by the audio conferencing module 107 as described above. However, because user A″ is not part of the policy defined by the group management service, their voice can be excluded or suppressed from the audio stream.

For example, in instances where the voice profile of user A″ is in the pattern matching database, a simple comparison of the components of the audio stream from device 1002 with patterns in the pattern matching database can be performed to exclude user A″. Alternately or additionally, in instances where the voice profile of user A″ is not in the pattern matching database, the system can exclude user A″ by specifically recognizing those participants that are desired participants in the audio conference—here, user A, user A′ and user B, and excluding or suppressing the voices of non-desired participants such as user A″.

Voice recognition and admission can take place at an originating device—here, device 1002, a receiving device such as device 1004, or an audio conferencing module that comprises part of platform 210. In situations where voice recognition and voice suppression takes place at an originating or receiving device, the group policy can be provided by the group management service 1016 to the individual devices in advance, so that each device's associated audio conferencing module can apply the techniques described herein to suppress undesired voices. This can be done without any action on the part of the users who are logged into the meeting—here, users A and B. Alternately or additionally, as in the embodiments described above, voice recognition and admission or suppression can be distributed throughout the system. For example, the audio conferencing module 107 on device 1002 can process the audio stream corresponding to users A, A′, and A″ and identify each of the voices. Device 1002 can then send, along with the audio stream, control data to the audio conferencing module on platform 210 so that the voice of user A″ can be suppressed or filtered.

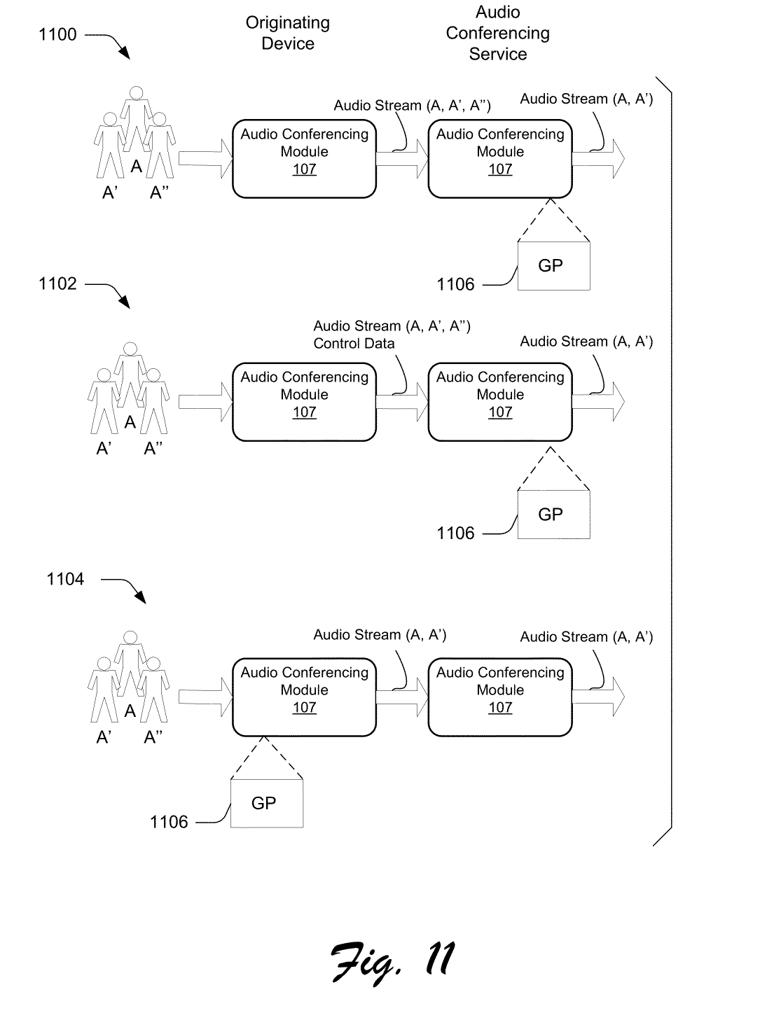

Accordingly, the audio conferencing module 107 and its associated functionality can be implemented at each particular device participating in an audio conference, including an audio conferencing service offered as part of a suite of services provided by platform 210. In addition, aspects of this functionality can be distributed across various devices and services participating in the audio conference. As an example, consider FIG. 11. There, three different scenarios are shown respectively at 1100, 1102, and 1104.

In scenario 1100, three participants are shown at an originating device having an audio conferencing module 107. In addition, an audio conferencing module 107 is illustrated as residing at the audio conferencing service. Further, a group policy 1106, as defined by the group management service, is provided as noted above. Specifically, in this particular instance the group policy 1106 indicates that users A, A′, B, and C are desired participants in the audio conference. In this particular example, assume that the voice associated with a user A″ is an undesired voice, as in the FIG. 10 example. In this particular instance, the audio conferencing module 107 at the originating device transmits an audio stream containing the voices of users A, A′, and A″. The audio conferencing service, by way of audio conferencing module 107, receives the audio stream and applies the group policy 1106 to the audio stream. Application of the group policy includes analyzing the audio stream to identify its component parts and then filtering out undesired voices—here, the voice associated with user A″. The audio conferencing service can then transmit a resultant audio stream to other participants in the conference.

In scenario 1102, the same three participants are shown at the originating device. In this particular example, assume again that the voice associated with user A″ is an undesired voice, as in the FIG. 10 example. In this particular instance, the audio conferencing module 107 at the originating device analyzes the audio signal having voice components associated with each of the users and identifies the components which represent the individual voices within the audio conference. Once the individual components are identified, the audio conferencing module provides control data identifying each particular voice within the audio stream. The complete audio stream with all three voices and the control data are transmitted to the audio conferencing service. At the audio conferencing service, the control data is used to enable filtering of one or more of the individual components that correspond to undesired voices in accordance with the group policy 1106. The resultant audio stream contains voices corresponding to users A and A′. The resultant audio stream can then be transmitted to the device of user B.

In scenario 1104, the same three participants are shown at the originating device. In this particular example, assume again that the voice associated with user A″ is an undesired voice, as in the FIG. 10 example. In this particular instance, the audio conferencing module 107 at the originating device has been provided with the group policy 1106. The originating device, by way of its audio conferencing module 107, processes the audio signal having voice components corresponding to users A, A′, and A″. In compliance with the group policy 1106, the audio conferencing module 107 identifies components which represent the individual voices within the audio conference. Once the individual components are identified, the audio conferencing module filters out one or more of the individual components that correspond to undesired voices—here, the voice corresponding to user A″. The resultant audio stream can then be transmitted to the device of user B.

Having considered example scenarios in accordance with one or more embodiments, consider now example methods in accordance with one or more embodiments.

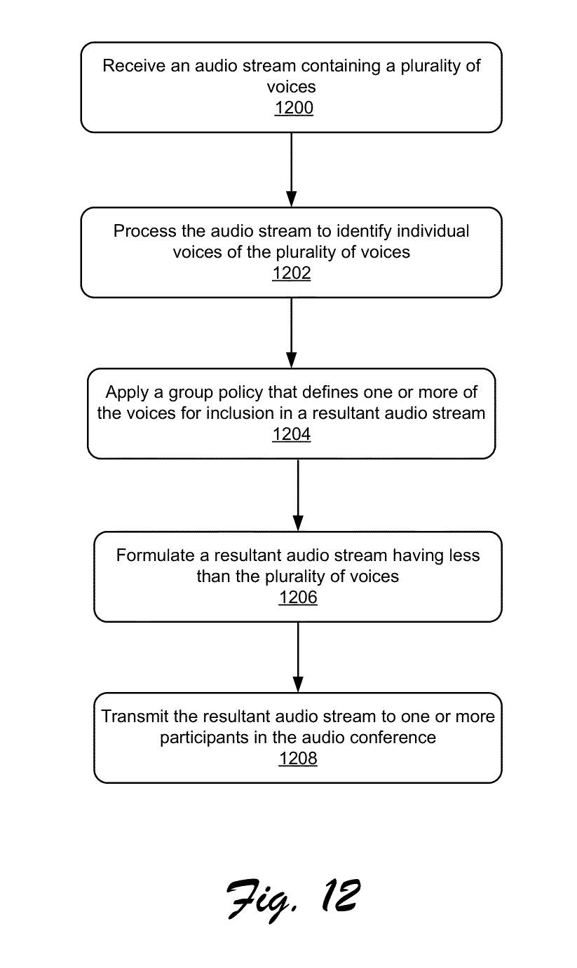

FIG. 12 is a flow diagram that describes steps in a method in accordance with one or more embodiments. The method can be implemented in connection with any suitable hardware, software, firmware, or combination thereof. In one or more embodiments, aspects of the method can be implemented by a suitably-configured audio conferencing module, such as audio conferencing module 107 described above. The audio conferencing module can reside on any of the computing devices described in relation to FIGS. 1-4, as well as others, without departing from the spirit and scope of the claimed subject matter. In addition, the functionality performed by the audio conferencing module can be distributed across multiple computing devices.

Step 1200 receives an audio stream containing a plurality of voices. In the illustrated and described embodiments, the voices are part of an audio stream that is generated during an audio conference with one or more remote participants. Step 1202 processes the audio stream to identify individual voices of the plurality of voices, e.g., by using any suitable type of voice recognition technique. This step can be performed in any suitable way, examples of which are provided above. Step 1204 applies a group policy that defines one or more of the voices for inclusion in a resultant audio stream, thus enabling selection of one or more of the voices for inclusion in the resultant audio stream. This step can be performed in any suitable way. For example, in at least some embodiments, this step can be performed by using the group policy to identify voices in the audio stream that are to be included in the resultant audio stream. Responsive to application of the group policy in step 1204, step 1206 formulates a resultant audio stream having less than the plurality of voices. The step can be performed in any suitable way. For example, in at least some embodiments, a filter can be automatically applied to the audio stream to formulate the resultant audio stream. Once the resultant audio stream has been formulated, step 1208 transmits the resultant audio stream to one or more participants in the audio conference. This method pertains to the processing described in connection with scenario 1100 in FIG. 11.

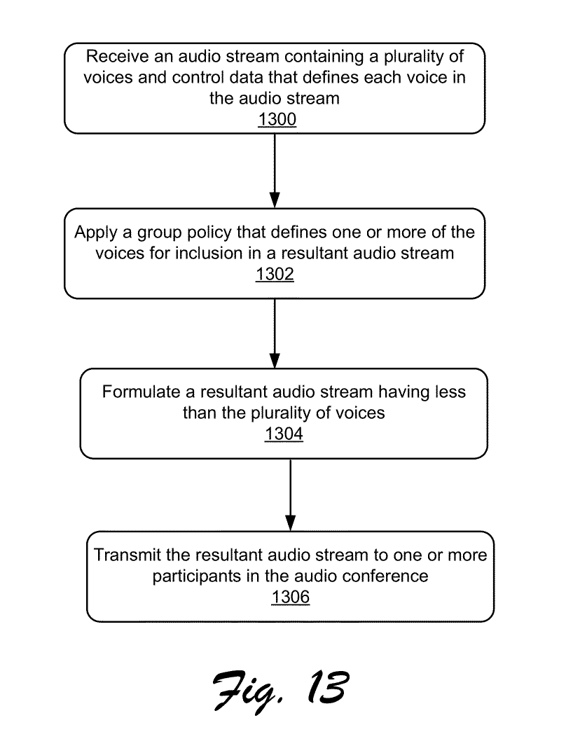

FIG. 13 is a flow diagram that describes steps in a method in accordance with one or more embodiments. The method can be implemented in connection with any suitable hardware, software, firmware, or combination thereof. In one or more embodiments, aspects of the method can be implemented by a suitably-configured audio conferencing module, such as audio conferencing module 107 described above. The audio conferencing module can reside on any of the computing devices described in relation to FIGS. 1-4, as well as others, without departing from the spirit and scope of the claimed subject matter. In addition, the functionality performed by the audio conferencing module can be distributed across multiple computing devices.

Step 1300 receives an audio stream containing a plurality of voices and control data that defines each voice in the audio stream. The control data can be generated using any suitable techniques, e.g., by using any suitable type of voice recognition technique. In the illustrated and described embodiments, the voices are part of an audio stream that is generated during an audio conference with one or more remote participants. Step 1302 applies a group policy that defines one or more of the voices for inclusion in a resultant audio stream, thus processing the stream to enable selection of one or more of the voices for inclusion in the resultant audio stream. This step can be performed in any suitable way. For example, in at least some embodiments, this step can be performed by using the group policy to identify voices specified in the control data of the audio stream that are to be included in the resultant audio stream. Responsive to application of the group policy in step 1302, step 1304 formulates a resultant audio stream having less than the plurality of voices. This step can be performed in any suitable way. For example, in at least some embodiments, a filter can be automatically applied to the audio stream to formulate the resultant audio stream that excludes those voices identified in the control data that are not part of the group policy. Once the resultant audio stream has been formulated, step 1306 transmits the resultant audio stream to one or more participants in the audio conference. This method pertains to the processing described in connection with scenario 1102 in FIG. 11.

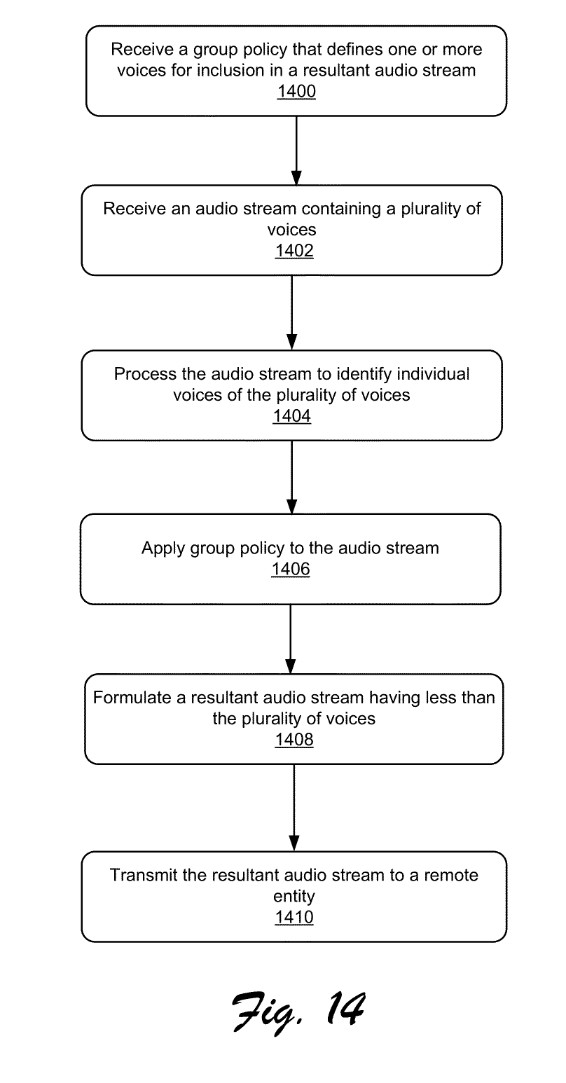

FIG. 14 is a flow diagram that describes steps in a method in accordance with one or more embodiments. The method can be implemented in connection with any suitable hardware, software, firmware, or combination thereof. In one or more embodiments, aspects of the method can be implemented by a suitably-configured audio conferencing module, such as audio conferencing module 107 described above. The audio conferencing module can reside on any of the computing devices described in relation to FIGS. 1-4, as well as others, without departing from the spirit and scope of the claimed subject matter. In addition, the functionality performed by the audio conferencing module can be distributed across multiple computing devices.

Step 1400 receives a group policy that defines one or more voices for inclusion in a resultant audio stream associated with an audio conference. This step can be performed in any suitable way. For example, in at least some embodiments, this step can be performed by a device that is to participate in an audio conference. Step 1402 receives an audio stream containing a plurality of voices. In the illustrated and described embodiments, the voices are part of an audio stream that is generated during an audio conference with one or more remote participants. Step 1404 processes the audio stream to identify the individual voices of the plurality of voices, e.g., by using any suitable type of voice recognition technique. Step 1406 applies the group policy to the audio stream, thus processing the stream to enable selection of one or more of the voices for inclusion in the resultant audio stream. This step can be performed in any suitable way. For example, in at least some embodiments, this step can be performed by using the group policy to identify voices in the audio stream that are to be included in a resultant audio stream. Responsive to application of the group policy in step 1406, step 1408 formulates a resultant audio stream having less than the plurality of voices. This step can be performed in any suitable way. For example, in at least some embodiments, a filter can be automatically applied to the audio stream to formulate the resultant audio stream that excludes those voices that are not identified by the group policy. Once the resultant audio stream has been formulated, step 1410 transmits the resultant audio stream to a remote entity. This method pertains to the processing described in connection with scenario 1104 in FIG. 11.

Having considered example methods in accordance with one or more embodiments, consider now an example device that can be utilized to implement one or more embodiments described above.

Example Device

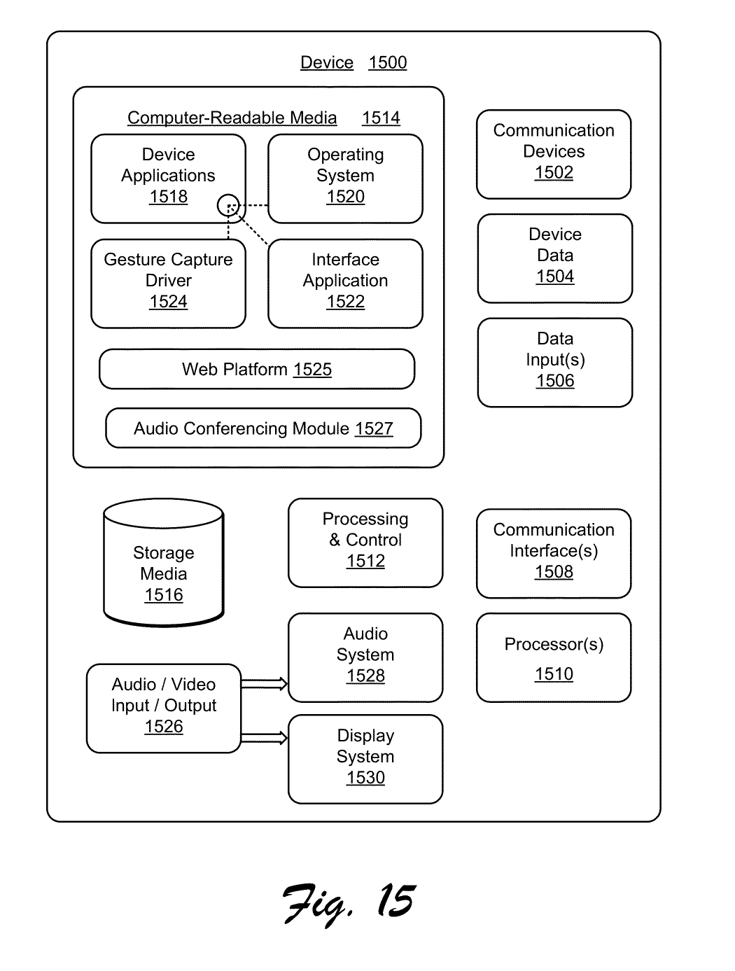

FIG. 15 illustrates various components of an example device 1500 that can be implemented as any type of computing device as described with reference to FIGS. 1 and 2 to implement embodiments of the techniques described herein. Device 1500 includes communication devices 1502 that enable wired and/or wireless communication of device data 1504 (e.g., received data, data that is being received, data scheduled for broadcast, data packets of the data, etc.). The device data 1504 or other device content can include configuration settings of the device, media content stored on the device, and/or information associated with a user of the device. Media content stored on device 1500 can include any type of audio, video, and/or image data. Device 1500 includes one or more data inputs 1506 via which any type of data, media content, and/or inputs can be received, such as user-selectable inputs, messages, music, television media content, recorded video content, and any other type of audio, video, and/or image data received from any content and/or data source.

Device 1500 also includes communication interfaces 1508 that can be implemented as any one or more of a serial and/or parallel interface, a wireless interface, any type of network interface, a modem, and as any other type of communication interface. The communication interfaces 1508 provide a connection and/or communication links between device 1500 and a communication network by which other electronic, computing, and communication devices communicate data with device 1500.

Device 1500 includes one or more processors 1510 (e.g., any of microprocessors, controllers, and the like) which process various computer-executable instructions to control the operation of device 1500 and to implement embodiments of the techniques described herein. Alternatively or in addition, device 1500 can be implemented with any one or combination of hardware, firmware, or fixed logic circuitry that is implemented in connection with processing and control circuits which are generally identified at 1512. Although not shown, device 1500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1500 also includes computer-readable media 1514, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1500 can also include a mass storage media device 1516.

Computer-readable media 1514 provides data storage mechanisms to store the device data 1504, as well as various device applications 1518 and any other types of information and/or data related to operational aspects of device 1500. For example, an operating system 1520 can be maintained as a computer application with the computer-readable media 1514 and executed on processors 1510. The device applications 1518 can include a device manager (e.g., a control application, software application, signal processing and control module, code that is native to a particular device, a hardware abstraction layer for a particular device, etc.). The device applications 1518 also include any system components or modules to implement embodiments of the techniques described herein. In this example, the device applications 1518 include an interface application 1522 and a gesture capture driver 1524 that are shown as software modules and/or computer applications. The gesture capture driver 1524 is representative of software that is used to provide an interface with a device configured to capture a gesture, such as a touchscreen, track pad, camera, and so on. Alternatively or in addition, the interface application 1522 and the gesture capture driver 1524 can be implemented as hardware, software, firmware, or any combination thereof. Additionally, computer readable media 1514 can include a web platform 1525 and an audio conferencing module 1527 that functions as described above.

Device 1500 also includes an audio and/or video input-output system 1526 that provides audio data to an audio system 1528 and/or provides video data to a display system 1530. The audio system 1528 and/or the display system 1530 can include any devices that process, display, and/or otherwise render audio, video, and image data. Video signals and audio signals can be communicated from device 1500 to an audio device and/or to a display device via an RF (radio frequency) link, S-video link, composite video link, component video link, DVI (digital video interface), analog audio connection, or other similar communication link. In an embodiment, the audio system 1528 and/or the display system 1530 are implemented as external components to device 1500. Alternatively, the audio system 1528 and/or the display system 1530 are implemented as integrated components of example device 1500.

### CONCLUSION

Various embodiments enable a system, such as an audio conferencing system, to remove voices from an audio conference in which the removed voices are not desired. In at least some embodiments, an audio signal associated with the audio conference is analyzed and split into components which represent the individual voices within the audio conference. Once the audio signal is split into its individual components, a control element can be applied to filter out one or more of the individual components that correspond to undesired voices.

In various embodiments, the control element can include incorporation of direct user controllability as by, for example, a suitably-configured user interface which enables a user to select one or more individual components for either exclusion or inclusion in the audio conference. Alternately or additionally, the control element can be automatically applied by the audio conferencing system. This can include application of policies, set in advance by way of a group access management system, to govern who can participate in a particular conference.

In yet other embodiments, a communication event is processed. The communication event comprises a signaling layer containing signal control information for managing the communication event. The signal control information includes identifiers of participants in the communication event. The communication event also includes a media layer containing at least an audio stream comprising voice signals of participants in the communication event. In operation, in at least some embodiments, the audio stream is received and processed to identify individual voices of the participants using at least one characteristic of each voice signal in the media layer. Control data is generated for controlling access of participants to the communication event based on the identified voices.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method comprising:
receiving an audio stream containing a plurality of voices, the audio stream being generated during an audio conference with multiple participants;
processing the audio stream to identify individual voices of the plurality of voices, the individual voices being identified by using one or more voice recognition techniques; and
enabling selection of one or more of the plurality of voices for inclusion or exclusion in a resultant audio stream by way of a filtering operation.

2. The method of claim 1, wherein said enabling selection comprises providing a control element in the form of a user interface that enables a user to select one or more of the voices for inclusion or exclusion in the resultant audio stream.

3. The method of claim 1 further comprising responsive to receiving selection of one or more of the voices, formulating the resultant audio stream to have less than the plurality of voices.

4. The method of claim 3 further comprising transmitting the resultant audio stream to one or more participants in the audio conference.

5. The method of claim 1, wherein said enabling selection comprises generating control data that defines individual voice components in the audio stream, the control data being effective to enable presentation of a control element in the form of a user interface that can be used to remove one or more of the plurality of voices.

6. The method of claim 5 further comprising responsive to said enabling, formulating the resultant audio stream, including the control data, and transmitting the resultant audio stream including the control data to one or more participants in the audio conference.

7. The method of claim 1, wherein said receiving is performed by a receiving device that receives the audio stream from a remote sending device that generated the audio stream.

8. The method of claim 7, wherein said enabling comprises providing a control element in the form of a user interface that enables a user at the receiving device to select one or more of the voices for inclusion or exclusion in the resultant audio stream.

9. The method of claim 8 further comprising responsive to receiving selection of one or more of the voices, formulating the resultant audio stream to have less than the plurality of voices and rendering the resultant audio stream at the receiving device.

10. The method of claim 1, wherein said enabling selection comprises applying a group policy that defines one or more of the plurality of voices for inclusion in the resultant audio stream.

11. The method of claim 10 further comprising, responsive to applying the group policy, formulating a resultant audio stream having less than the plurality of voices and transmitting the resultant audio stream to one or more participants in the audio conference.

12. The method of claim 1, wherein said receiving an audio stream further comprises receiving control data that identifies individual voices of the plurality of voices appearing in the audio stream; and said enabling selection comprises applying a group policy that defines one or more of the plurality of voices for inclusion in the resultant audio stream, the one or more of the plurality of voices being specified in the control data.

13. The method of claim 12 further comprising, responsive to applying the group policy, formulating a resultant audio stream having less than the plurality of voices and transmitting the resultant audio stream to one or more participants in the audio conference.

14. The method of claim 1 further comprising receiving a group policy that defines one or more voices for inclusion in a resultant audio stream associated with the audio conference; and wherein said enabling selection comprises applying the group policy to the audio stream; and responsive to applying the group policy formulating a resultant audio stream having less than the plurality of voices and transmitting the resultant audio stream to a remote entity.

15. One or more computer readable storage media having instructions stored thereon that, responsive to execution by a computing device, cause the computing device to perform operations comprising:
receiving an audio stream containing a plurality of voices, the audio stream being generated during an audio conference with multiple participants;
processing the audio stream to identify individual voices of the plurality of voices, the individual voices being identified by using one or more voice recognition techniques; and
enabling selection of one or more of the plurality of voices for inclusion or exclusion in a resultant audio stream by way of a filtering operation.

16. The one or more computer readable storage media of claim 15, wherein said enabling selection comprises presenting, on a device that generated the audio stream, a user interface that enables a user to select one or more of the voices for inclusion or exclusion in the resultant audio stream.

17. The one or more computer readable storage media of claim 15, wherein said enabling selection comprises causing presentation, on a device other than a device that generated the audio stream, a user interface that enables a user to select one or more of the voices for inclusion or exclusion in the resultant audio stream.

18. The one or more computer readable storage media of claim 15, wherein said enabling selection comprises applying a group policy that defines one or more of the plurality of voices for inclusion in the resultant audio stream.

19. A computing device comprising:
an audio conferencing module configured to receive an audio stream containing a plurality of voices, the audio stream being generated during an audio conference with multiple participants;
an audio processing module configured to process the audio stream to identify individual voices of the plurality of voices, the individual voices being identified by using one or more voice recognition techniques; and
an access control module configured to enable selection of one or more of the plurality of voices for inclusion or exclusion in a resultant audio stream by way of a filtering operation effected by one or more of:
a user interface that enables a user to select one or more of the voices for inclusion or exclusion in the resultant audio stream; or
automatic application of a group policy that defines one or more of the plurality of voices for inclusion in the resultant audio stream.

20. The computing device of claim 19, wherein the computing device comprises one other than one associated with participants in the audio conference; and
said enabling selection is performed through application of the group policy.

21. A computing device comprising:
an audio conferencing module configured to receive an audio stream containing a plurality of voices and control data, the audio stream being generated during an audio conference with multiple participants;
an audio processing module configured to process the audio stream and control data to identify individual voices of the plurality of voices; and
an access control module configured to use the control data to enable selection of one or more of the plurality of voices for inclusion or exclusion in a resultant audio stream by way of a filtering operation effected by a user interface that enables a user to select one or more of the voices for inclusion or exclusion in the resultant audio stream.
